(19) United States
(12) Patent Application Publication
(10) Pub. No.: US 2006/0224401 A1
(43) Pub. Date: Oct. 5, 2006

(54) Meal data objects having recipes and food items

(76) Inventor: Timothy D. Hunt, Seattle, WA (US)

Correspondence Address: LAW OFFICES OF MICHAEL DRYJA, 704 228TH AVENUE NE, PMB 694, SAMMAMISH, WA, 98074, US

(21) Appl. No.: 11/097,539

(22) Filed: Apr. 2, 2005

(51) Int. Cl. G06Q 99/00; G06Q 30/00; G06Q 50/00

(52) U.S. Cl. 705/1; 705/15

(57) ABSTRACT

A meal data object is generated by a user, where the meal data object includes recipes and food items. The meal data object may more specifically include a description and a meal type for the meal data object. For each recipe of the meal data object, the meal data object may include a description, a dish type, and/or a meal part for the recipe. The meal data object may also include a description for each food item. The meal data object is published so that it is viewable by other users. The users can navigate the meal data objects to select desired meals. A shopping list for the food items of the meal data object can be generated, such that each food item is listed once in the shopping list regardless of the number of recipes of the meal data object within which the food item is present.

### BACKGROUND OF THE INVENTION

A recipe can generally be defined as a list of ingredients and a set of directions for making or preparing some type of food. Recipes are commonly used by both amateur and expert cooks and other types of food preparers to make or prepare items or types of food. Historically, recipes were gathered together in cookbooks, which are books of collections of different recipes. Alternatively, many cooks and food preparers keep recipes on cards, either professionally or manually prepared, and organize the cards in recipe boxes or holders.

With the increasing popularity of computer technology, however, recipes are now frequently maintained in computerized form. Originally, recipes were maintained only in special recipe-oriented computer programs, or general-purpose database or spreadsheet computer programs. These programs may allow users to add their own recipes for storage on the computer, and/or may come with a large number of predefined recipes, thus supplanting traditional cookbooks. The programs may be run on single computers, or may be run over a network. For example, the recipes themselves may be stored on one computer, or on a network-attached storage (NAS) device, and be accessed by other computers on the network.

More recently, recipe storage and access over the Internet has become popular. There are a number of worldwide web (WWW) sites that cater to recipes. A user accesses such web sites using a web browser program on his or her computer or other type of computing device, and thus accesses the recipes through the web sites. The recipes themselves are stored on a server computer or other type of computing device at a remote location hosted by the organization that owns the web site, or which is associated with the web site owner. Having recipes accessible over the Internet enables a large number of users to access the recipes stored on recipe-oriented web sites simultaneously, and can also allow users to more easily share recipes with other like-minded users.

Recipes do not satisfy all of an amateur chef or cook's meal-planning needs. For a given meal, an amateur chef or cook still may have to select from a number of recipes to come up with two, three, or more that together make up the meal. The individual then has to determine the ingredients that make up all the recipes of the meal and prepare a shopping list. Furthermore, one desired recipe may serve eight people, for instance, while another desired recipe may serve five people, forcing the person to try to figure out how to adjust both recipes to serve a different desired number of people, such as four. Providing recipes to an amateur chef or cook, in other words, does not mean that such an individual is home free when it comes to planning a meal to serve others.

### SUMMARY OF THE INVENTION

The present invention relates to meal data objects having recipes and food items. A method of one embodiment of the invention includes generating a meal data object by a user, where the meal data object includes recipes and food items. The meal data object may more specifically include a description and a meal type for the meal data object. For each recipe of the meal data object, the meal data object may include a description, a dish type, and/or a meal part for the recipe. The meal data object may also include a description for each food item. The meal data object is published so that it is viewable by other users. The users can navigate the meal data objects to select desired meals. A shopping list for the food items of the meal data object can be generated, such that each food item is listed once in the shopping list regardless of the number of recipes of the meal data object within which the food item is present.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a diagram of an example representative meal data object, according to an embodiment of the invention.

FIG. 2 is a flowchart of a method for performance relative to a number of meal data objects, according to an embodiment of the invention.

FIG. 3 is a flowchart of a method for generating a meal data object, according to an embodiment of the invention.

FIGS. 4A, 4B, and 4C are diagrams depicting example navigations among meal data objects, according to varying embodiments of the invention.

FIG. 5 is a flowchart of a method for generating a shopping list for the food items of a meal data object, according to an embodiment of the invention.

FIG. 6 is a flowchart of a method for outputting an instruction package for a meal data object, according to an embodiment of the invention.

FIG. 7 is a diagram of a representative system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

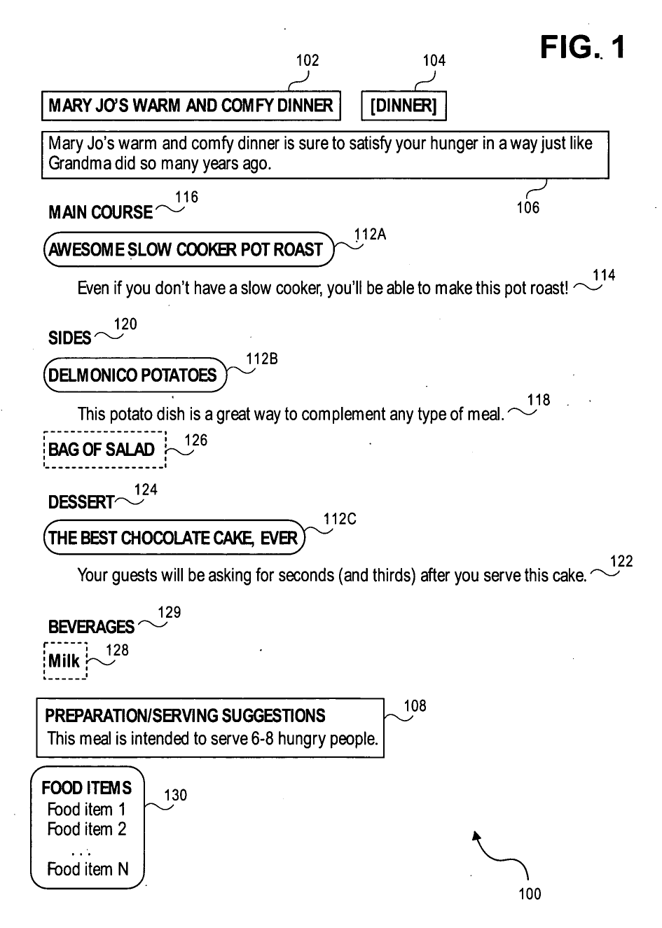

FIG. 1 shows an example representative meal data object 100, according to an embodiment of the invention. The meal data object 100 includes data representing a title 102, a meal type 104, a description 106, and preparation and/or serving suggestions 108. The title 102, the meal type 104, the description 106, and the preparation and/or serving suggestions 108 are applicable to the meal data object 100 as a whole, and are not particular to and not derived from any recipe or food item encompassed by the meal data object 100. It is noted that the term object is used herein in an all-encompassing sense, and is not meant to limit embodiments of the invention to software data objects of the type that are employed within object-oriented programming (OOP) paradigms. Rather, the term data object as used herein can also encompass data structure, data entity, and so on, and thus includes any type of structuring or storage of data in this sense.

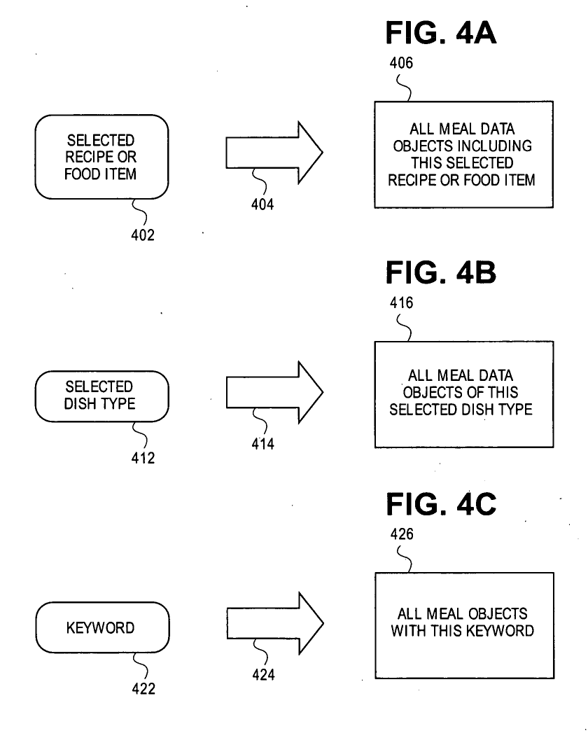

Furthermore, the meal data object 100 can include other information that is applicable to the meal data object 100 as a whole, and that is not particular to or derived from any recipe or food item encompassed by the meal data object. For example, the user creating the meal data object 100 may be able to enter one or more keywords to be associated with the meal data object 100. The keywords are subsequently searchable so that meal data objects matching selected keywords can be displayed, as will be described in relation to FIG. 4C.

The meal data object 100 encompasses, or aggregates, data representing a number of recipes. For example, as depicted in FIG. 1, the meal data object 100 encompasses or aggregates data representing recipes 112A, 112B, and 112C, collectively referred to as the recipes 112. The recipes 112 may themselves be standalone data objects or structures that may just be referred or referenced by the meal data object 100. At its most basic level, the meal data object 100 is a collection, or aggregation, of the recipes 112, as well as a number of food items.

Each of the recipes 112 has a description, and a dish type or meal part, where either of which may be derived from data present within the recipe itself, or subsequently added to the recipe and thus existing only as part of the meal data object 100. For example, the recipe 112A has the description 114 and the dish type or meal part 116; the recipe 112B has the description 118 and the dish type or meal part 120; and, the recipe 112C has the description 122 and the dish type or meal part 124. The dish type or meal part of a recipe denotes the part of the meal for, or the type of dish of, the recipe. A number of recipes can have the same dish type or meal part, even though this is not shown in FIG. 1. A recipe is at least a collection of ingredients, and directions or instructions for how to prepare those ingredients to make a desired food, dish, and so on. The collection of ingredients and the directions or instructions of each of the recipes 112 is not depicted in FIG. 1 for illustrative convenience.

The meal data object 100 encompasses, or aggregates, data representing a number of food items as well. For example, as depicted in FIG. 1, the meal data object 100 encompasses or aggregates data representing food items 126 and 128. Each of the food items has a dish type or meal part, and optionally a description, the latter which is not shown in FIG. 1. The dish type or the meal part may be derived from the data of the food item itself, or subsequently added to the food item and thus existing only as part of the meal data object 100. For example, the food item 126 has the dish type or meal part 120, whereas the food item 128 has the dish type or meal part 129. The dish type or meal part of a recipe denotes the part of the meal, or the type of dish of, the food item. A number of food items can have the same dish type or meal part, and these dish types or meal parts can be the same as that for one or more recipes.

A food item is different than a recipe in that it is a discrete item, not made up of a collection of ingredients and directions or instructions for how to prepare those ingredients. For example, whereas the recipe 112B may include ingredients such as a bag of potatoes, salt, vinegar, and oil, and directions for how to turn these ingredients into the dish of Delmonico potatoes, the food item 126 is a discrete item, a bag of salad, such as that which is available for purchase at the grocery store. Stated another way, the ingredients of a recipe may be considered discrete food items that have to be prepared to turn them into a desired dish. By comparison, a food item is itself a discrete item, which may not have to be prepared to be turned into a desired dish, but already is a desired dish.

The meal data object 100 further encompasses data representing additional food items 130, which can be considered the ingredients of all of the recipes 112, and also the food items 126 and 128. That is, the food items 130 may be considered the grocery or shopping list to make the meal data object 100. The food items 130 thus include all of the ingredients required by the recipes 112, as well as the discrete food items 126 and 128 that are part of the meal data object 100. As will be described, each of the food items 130 is listed once, even where it is present in more than one of the recipes 112 and the food items 126 and 128. For example, if two potatoes are needed in the recipe 112A and six potatoes are needed in the recipe 112B, a single food item corresponding to potatoes is listed as eight potatoes, instead of one food item listed as two potatoes and another food item listed as six potatoes.

It is noted that, in general, a meal data object includes at least one recipe, and thus at least one food item, and does not have to include a discrete food item. In the context of FIG. 1, for instance, the discrete food items 126 and 128 are not required, whereas at least one of the recipes 112 is required to define the meal data object 100. The food items 130 in such instance would include the ingredients for the one or more of the recipes 112. In this way, a meal data object includes at least one recipe, and at least one food item corresponding to the food items of the recipe(s), and may optionally but not necessarily include at least one discrete food item. Furthermore, in one embodiment, a meal data object can include at least one discrete food item, and not include any recipes.

Embodiments of the invention thus are concerned with the novel meal data object, allowing users to aggregate recipes and discrete food items into complete meals, as well as allowing the users to manipulate the meal data objects as will be described. A meal data object is more than just an aggregation or an encompassment of recipes and food items. By adding additional data to the meal data object, such as meal parts or dish types for each recipe and each food item, as well as a title, description, and/or serving or preparation suggestions, the meal data object represents a complete meal that an individual can use. Furthermore, the meal data object does not represent data generated from scratch. Because the food items and/or the recipes may be pre-existing, meal data objects can be easily generated by encompassing food items and recipes that go together well, and adding additional data as needed.

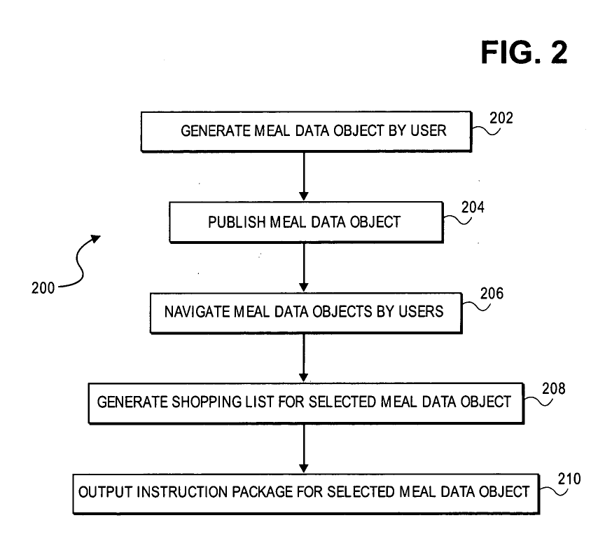

FIG. 2 shows a method 200 that presents an overview of the different types of manipulations that can be performed relative to meal data objects, according to an embodiment of the invention. At least some parts of the method 200, as well as other methods of the invention, are performed by corresponding computer program parts of a computer program stored on a computer-readable medium. The computer program parts may be computer program sections, routines, subroutines, code, objects, and so on. The computer-readable medium may be a volatile or a non-volatile medium, as well as a magnetic, optical, and/or semiconductor medium. Furthermore, the method 200, as well as other methods of the invention, may be performed relative to a single computing system or device, or to multiple computing systems or devices communicatively connected to one another in a peer-to-peer and/or client-server manner.

First, a meal data object may be generated by a user (202). For example, the user may have a client computing device that is communicatively connected to a server computing device over a network like the Internet. The user, through his or her client computing device, interacts with a web site hosted by the server computing device in this example to generate a meal data object.

The meal data object is then said to be published (204). Publication of the meal data object means storage of the meal data object in such a way that other users are able to view the meal data object. Continuing the previous example, the user may indicate that other users of the web site can view the meal data object. The meal data object is thus stored on the server computing device or another type of storage, and other users are able to navigate to and retrieve the meal data object for viewing and other manipulation.

Therefore, users are able to navigate a collection of meal data objects to locate a desired, or selected, meal data object (206). As will be described, there are a number of different ways for users to be able to navigate meal data objects. For a selected meal data object, a user may also request that a shopping list be generated (208), so that the user is able to prepare the meal. The user may also request that an instruction package be generated for the selected meal data object (210), which may include all of the recipes in detail, all of the food items, and the shopping list for the desired meal data object.

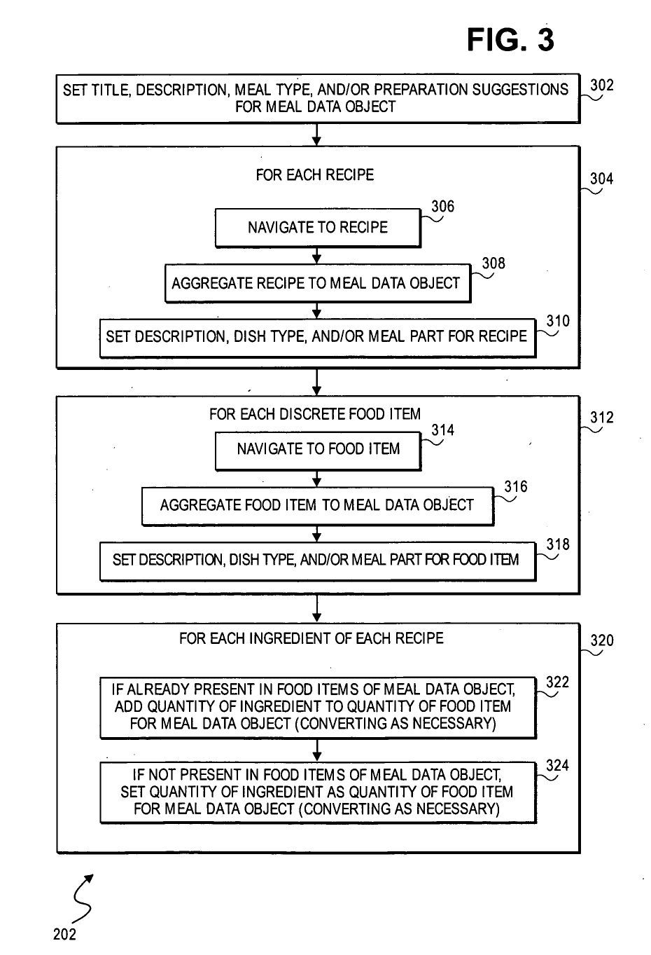

FIG. 3 shows a method that may be performed for generating the meal data object in 202 of the method 200 of FIG. 2, according to an embodiment of the invention. For a meal data object to be generated, the title, description, meal type, and/or preparation/serving suggestions are set by the user (302). For example, the user may select a link on a web site corresponding to the creation of a new meal. A meal data object is then created, allowing the user to fill in data fields corresponding to the title, description, meal type, and/or preparation/serving suggestions for the meal. The user may also set other data or information of the meal data object.

Next, a number of actions, steps, and/or acts are performed for each recipe of the meal data object (304). First, the user navigates to a desired recipe (306). For example, the user may browse the recipes accessible through a web site, and tag the recipes that he or she wishes to incorporate as part of the meal. The user may also search for desired recipes by keywords, title words, and so on. The user may further enter a new recipe, or may chance upon a recipe by discovering it in a different meal data object, or as a recipe that uses a desired ingredient. Each of these examples is an example of navigation to a desired recipe, although embodiments of the invention are not limited to such examples of recipe navigation.

The desired recipe is thus aggregated to the meal data object (308). As has been described, in one embodiment the recipe is not duplicated within the meal data object. Rather, there is a reference or pointer within the meal data object to the desired or selected recipe in question. That is, the recipe exists as a separate data object, entity, or structure, apart from the meal data object. The recipe is thus not merely a part of the meal data object, but can by itself be searched, categorized, cataloged, indexed, and so on, and further can be referenced or pointed to by other meal data objects.

Information regarding the recipe that can be particular to the reference of the recipe within the meal data object, such as description, dish type, and/or meal part of the recipe, may be set by the user (310). Such setting may include extracting this information from the recipe data itself, or adding additional information to the recipe that is unique to and stored within the meal data object in its reference to the recipe. For example, the description of the recipe may be automatically extracted from the recipe data, whereas the dish type of the recipe may be additional information that is stored within the meal data object alongside the reference or pointer to the recipe, and thus is information that is not part of the recipe itself.

A number of actions, steps, and/or acts may also be performed for each discrete food item of the meal data object (312). Discrete food items are separate entities or parts of the meal, and are not to be confused by the food items that also include or encompass the ingredients of the recipes. For instance, in the example of FIG. 1, the food items 126 and 128 are discrete food items, because they are separate parts of the meal represented by the meal data object 100. By comparison, the ingredients of the recipes 112, while also food items, are not discrete food items, because they are not separate parts of the meal represented by the meal data object 100.

First, the user navigates to a desired food item (314). As before, the user may browse the food items accessible through a web site, and tag the food items that he or she wishes to incorporate as part of the meal data object. The user may search for desired food items, enter new food items, and so on. Furthermore, the web site itself may suggest food items that go well with selected recipes or other food items. Such suggested food items may be those that other users have recommended, that maintainers of the site recommend, or that sponsors have paid for to be listed. Each of these examples is an example of navigation to a desired food item, although embodiments of the invention are not limited to such examples of discrete food item navigation.

The desired food item is thus aggregated to the meal data object (316). As with recipes, in one embodiment the desired food object is not duplicated within the meal data object, but rather there is a reference or pointer within the meal data object to the desired or selected discrete food item in question. The food item therefore can exist as a separate data object, entity, or structure, apart from the meal data object, and thus is not merely a part of the object, but can by itself be search, categorized, and otherwise manipulated, such as being referenced or pointed to by other meal data objects.

Information regarding the food item that can be particular to the reference of the discrete food item within the meal data object, such as description, dish type, and/or meal part of the food item, may be set by the user (318). As with recipes, such setting may include extracting this information from the food item data itself, or adding additional information to the food item that is unique to and stored within the meal data object in its reference to the discrete food item. For example, the description of the food item may be automatically extracted from the food item data, whereas the meal part of the food item may be additional information that is stored within the meal data object alongside the reference or pointer to the food item, and thus is information that is not part of the discrete food item itself.

In one embodiment, additional actions, steps, and/or acts may also be performed for each ingredient of each recipe (320). In this embodiment, it is noted that the user may be able to enter a desired number of servings for each recipe, which may differ from a preset or suggested number of servings already present for the recipe. Therefore, a conversion is performed to ensure that the quantity of each ingredient (i.e., each food item) of each recipe is ultimately equal to that needed for the desired number of servings for that recipe, and not necessarily just for the suggested or preset number of servings for the recipe.

For example, the suggested or preset number of servings for a given recipe may be four, whereas the user-desired number of servings for this recipe may be eight. If this recipe uses four cups of brown sugar, then the conversion to be performed would be to double the quantity of this food item, to eight cups of brown sugar. Performing this conversion ensures that the recipe's preset or suggested number of servings is made equal to the number of servings that the user desires for this recipe.

If a given ingredient of a given recipe is already present in the food items of the meal data object, then the quantity of this ingredient as dictated by the recipe is added to the existing quantity of that food item for the meal data object (322), performing as necessary a conversion as has been described. For example, based on the addition of ingredients of other recipes, there may be a food item for the meal data object of sugar, with a quantity of one-half cup. If the ingredient of a recipe for which 322 is currently being performed is also sugar, with a (converted) quantity of one cup, then this quantity is added to the existing quantity of sugar for the meal data object, to yield one and one-half cups of sugar for the meal data object. Therefore, no food item is listed twice in the meal data object, even if it is an ingredient to more than one recipe.

If a given ingredient of a given recipe is not already present in the food items of the meal data object, then the quantity of this ingredient as indicated by the recipe is set as the quantity for a new food item for the meal data object (322), performing as necessary a conversion as has been described. For example, if the ingredient of a recipe for which 322 is currently being performed is an onion, with a (converted) quantity of one, and if no other ingredients of other recipes also added as food items for the meal data object are an onion, then a new food item, onions, is added to the meal data object. The quantity for this new food item is set as one.

FIGS. 4A, 4B, and 4C show different types of navigation that may be performed in navigating the meal data objects by users in 206 of FIG. 2, according to varying embodiments of the invention. Users may via their client computing devices access a web site hosted by a server computing device over the Internet or another network. FIGS. 4A, 4B, and 4C diagrammatically show different examples of how such users may browse meal data objects to locate one or more desired meal data objects. Embodiments of the invention, however, are not limited to the examples of FIGS. 4A, 4B, and 4C.

In FIG. 4A, there is a selected recipe or food item 402. For instance, the user may have been navigating recipes or food items, and has reached the selected recipe or food item 402. For purposes of navigation of meal data objects, as indicated by the arrow 404, all the meal data objects 406 that include (viz., aggregate or encompass) the selected recipe or food item 402 are displayed. For example, for a selected recipe or food item, besides information regarding this recipe or food item, the web site may display to the user an additional information section entitled “This recipe or food item appears in the following meals,” with a listing of the titles of all of the meal data objects 406. The titles may themselves by hyperlinks that when selected direct a user to the display of the selected one of the meal data objects 406.

In FIG. 4B, there is a selected dish type 412. For instance, the user may have selected a link entitled “See dinner meals,” where the dish type 412 in this example is “dinner.” For purposes of navigation of meal data objects, as indicated by the arrow 414, all the meal data objects 416 that are of this selected dish type 412 are displayed. For example, meal data objects may be of the dish type “breakfast,” “lunch,” and/or “dinner.” Where the selected dish type 412 is “dinner,” only those meal data objects 416 that are exclusively or non-exclusively of the dish type “dinner” are displayed.

In FIG. 4C, there is a keyword 422. For instance, the user may wish to search for all meals that include in their descriptions the keyword “fast.” For purposes of navigation of meal data objects, as indicated by the arrow 412, all the meal data objects 426 that include the keyword 422 in their sets of keywords are displayed. Keywords may also be used to search for other parts of the meal data objects, including the recipes and discrete food items that are merely pointed to or referenced by the meal data objects, and which are not only a part thereof.

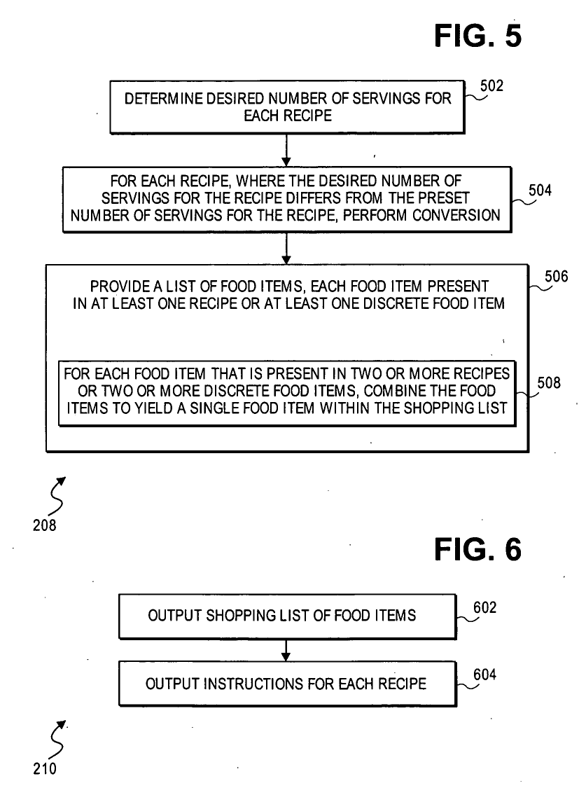

FIG. 5 shows a method that may be performed for generating the shopping list in 208 of the method 200 of FIG. 2, according to an embodiment of the invention. The method of FIG. 5 is performed in relation to a selected or desired meal data object. First, the desired number of servings for each recipe may be determined (502). For example, the user may be given the opportunity to enter in the desired number of servings for each recipe. The desired number of servings for each recipe is independently determined. Thus, the desired number of servings of one recipe may be different from the desired number of servings of another recipe.

For each recipe, where the desired number of servings for the recipe differs from the preset or suggested number of servings for the recipe, an appropriate conversion is performed (504). In particular, the quantity of each food item of the recipe is converted based on the desired number of servings and the preset number of servings, in accordance with the formula desired quantity equals listed quantity times desired number of servings, divided by preset number of servings. The listed quantity of a food item is the quantity of the food item in the recipe already, which is the quantity of this food item needed for the preset number of servings for the recipe. The entry of a desired number of servings in 502 and the conversion performed in 504 may also be performed as to each discrete food item.

Furthermore, generating the shopping list includes providing a list of all the food items needed to prepare the recipes of the meal data object, and also that correspond to the discrete food items of the meal data object (506). Each food item in the list is, in other words, present in at least one recipe or in at least one discrete food item. Preferably, no food item is a duplicate of another food item. Thus, similar to as has been described in relation to 320 of FIG. 3, for each food item that is present in two or more recipes, in two or more discrete food items, or in at least one recipe and in at least one discrete food item, the food items are combined to yield a single food item within the shopping list (508). In so combining, the quantities of the food items in the two or more recipes, discrete food items, or in the at least one recipe and the at least one discrete food item are added together similar to as has been described in relation to 320 of FIG. 3.

Furthermore, in one embodiment the listing of the food items includes changing the unit of measure of a food item and the name that the food item is given. For example, an appropriate conversion can be made so that an ingredient such as “chopped onions” is translated to an appropriate quantity of “onions”—as opposed to “chopped onions” within the shopping list. Where the quantity of onions exceeds a predetermined threshold, the unit of measure may further change from a number of onions to a weight of onions, such as a five-pound bag or a ten-pound bag of onions. Thus, the listing of food items can include appropriately changing the name of a food item and the unit of measure of the food item based on what a user is likely to shop for in a grocery store. In the previous example, the user may be able to buy one or two individual onions, but if a larger number of onions is required, then it may make more sense for the user to purchase a bag of onions of a given weight.

FIG. 6 shows a method that may be performed for outputting the instruction package in 210 of the method 200 of FIG. 2, according to an embodiment of the invention. The method of FIG. 6 is also performed in relation to a selected or desired meal data object. First, the shopping list of food items that has been generated is output (602). As has been described, each food item is preferably listed once in the shopping list, regardless of the number of recipes or the number of discrete food items of the selected meal data object within which the food item is present.

Next, the instructions for each recipe to prepare that recipe are output (604). Other information regarding the meal data object may also be output. Output in this context may include displaying the shopping list, the instructions for each recipe, and so on, as a web page of a web site, creating a separate human-readable data file with such content, and so on. Output may also include printing this content to a printing device, like an inkjet or a laser printer. Output may further including emailing the instruction package to an email address.

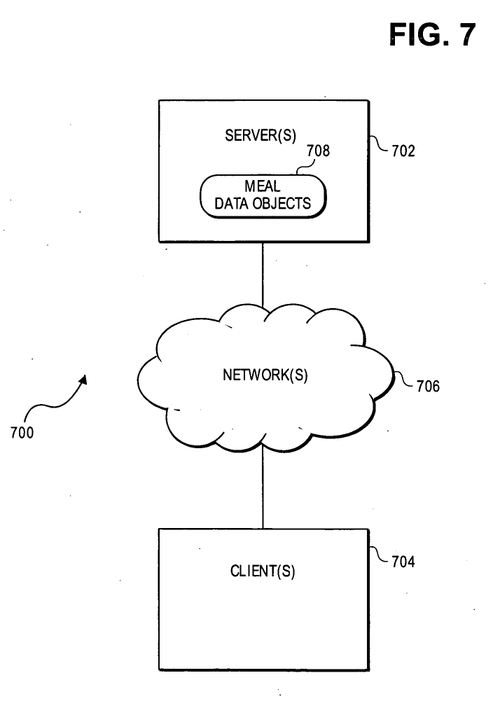

FIG. 7 shows a representative system 700, according to an embodiment of the invention. The system 700 includes one or more servers 702 and one or more clients 704 communicatively connected to one another via one or more networks 706. The servers 702 are server computing devices, whereas the clients 704 are client computing devices, such as desktop or laptop computers, personal digital assistant (PDA) devices, mobile phones, set-top boxes, as well as other types of computing devices. The networks 706 may be or include one or more of: the Internet, intranets, extranets, local-area networks (LAN's), wide-area networks (WAN's), telephony networks, wired networks, and wireless networks, among other types of networks.

The servers 702 store meal data objects 708, that can be manipulated, viewed, and created by the users of the clients 704 over the networks 706 as has been described. In an exemplary embodiment of the invention, the servers 702 host an Internet web site in which the stored meal data objects 708 can be manipulated, viewed, and created, by the users of the clients 704 over the networks 706. In particular, the clients 704 run web-browsing computer programs to access the Internet web site hosted by the servers 702 to manipulate, view, and create the meal data objects 708.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of the disclosed embodiments of the present invention. Therefore, it is manifestly intended that this invention be limited only by the claims and equivalents thereof.

What is claimed is:

1. A method comprising:
generating a meal data object by a user, the meal data object comprising a plurality of recipes and a plurality of food items;
publishing the meal data object so that the meal data object is viewable by a plurality of users; and,
navigating a plurality of meal data objects, including the meal data object, by the users, including viewing the meal data objects.

2. The method of claim 1, wherein generating the meal data object by the user comprises, for each recipe of the meal data object:
navigating to the recipe, the recipe including a number of recipe food items needed to prepare the recipe; and,
aggregating the recipe to the meal data object, including aggregating the recipe food items to the food items of the meal data object.

3. The method of claim 1, wherein generating the meal data object by the user comprises, for each recipe of the meal data object:
for each recipe food item of the recipe that is already present in the food items of the meal data object, adding a quantity of the recipe food item to a quantity of the food item of the meal data object; and,
for each recipe food item of the recipe that is absent from the food items of the meal data object, adding a food item to the meal data object for the recipe food item, including setting a quantity of the food item of the meal data object as a quantity of the recipe food item within the recipe.

4. The method of claim 3, wherein generating the meal data object comprises:
for each recipe of the meal data object, for each recipe food item of the recipe that is already present in the food items of the meal data object, adding the quantity of each recipe food item to the quantity of the food item of the meal data object comprises converting the quantity of the recipe food item based on a desired number of servings of the recipe and a preset number of serving for the recipe, where the desired number of servings of the recipe is not equal to the preset number of servings for the recipe, and
for each recipe of the meal data object, for each recipe food item of the recipe that is absent from the food items of the data object, adding the food item to the meal data object for the recipe food item comprises converting the quantity of the recipe food item based on the desired number of servings of the recipe and the preset number of servings for the recipe, where the desired number of servings of the recipe is not equal to the preset number of servings for the recipe.

5. The method of claim 1, wherein generating the meal data object by the user comprises setting at least one of a description and a meal type of the meal data object.

6. The method of claim 1, wherein generating the meal data object by the user comprises, for each of at least one of the recipes, setting at least one of a description, a dish type, and a meal part for the recipe as aggregated into the meal data object.

7. The method of claim 1, wherein generating the meal data object by the user comprises, for each of at least one of the food items, setting a description.

8. The method of claim 1, wherein publishing the meal data object comprises saving the meal data object to a storage accessible and navigable by all the users.

9. The method of claim 1, wherein navigating the meal data objects comprises viewing all of the meal data objects that include at least one of a selected recipe and a selected food item.

10. The method of claim 1, wherein navigating the meal data objects comprises viewing all of the meal data objects that have a selected meal type.

11. The method of claim 1, wherein navigating the meal data objects comprises viewing all of the meal data objects that have one or more selected keywords.

12. The method of claim 1, further comprising generating a shopping list of the food items needed to prepare the recipes of a selected meal data object.

13. The method of claim 12, wherein generating the shopping list comprises, for each food item that is present in two or more of the recipes of the selected meal data object, adding a quantity of the food item of each of the recipes to which the food item is present to yield a single quantity of the food item for the shopping list.

14. The method of claim 12, wherein generating the shopping list comprises, for each recipe:
determining a desired number of servings for the recipe; and, where the desired number of servings for the recipe differs from a preset number of servings for the recipe,
converting a quantity of each food item based on the desired number of servings and the preset number of servings.

15. The method of claim 1, further comprising outputting an instruction package for a selected meal data object, by:
outputting a shopping list of the food items needed to prepare the recipes of the selected meal data object, such that each food item is listed once in the shopping list regardless of a number of the recipes of the selected meal data object within which the food item is present; and,
outputting instructions for each recipe of the selected meal data object.

16. A system comprising:
at least one server computing device to enable a plurality of users to generate a plurality of meal data objects, publish the meal data objects for viewing by all of the users, and to navigate the meal data objects to select desired of the meal data objects, each meal data object comprising a plurality of recipes and a plurality of food items; and,
at least one client computing device on which the users communicate with the server computing device to generate, publish, and navigate the meal data objects.

17. The system of claim 16, wherein each meal data object further comprises a quantity of each food item used in one or more of the recipes of the meal data object, such that as each recipe is added to the meal data object, a quantity of each of a plurality of recipe food items is converted based on a desired number of servings of the recipe and a preset number of servings of the recipe, and added to the quantity of a corresponding food item of the meal object.

18. The system of claim 16, wherein each meal data object further comprises:
a description of the meal data object;
a meal type for the meal data object;
for each of at least one of the recipes of the meal data object, a description of the recipe; and,
for each of at least one of the recipes of the meal data object, at least one of a dish type and a meal part of the recipe.

19. A computer-readable medium having a computer program stored thereon and comprising:
a first computer program part to generate a meal data object by a user, the meal data object comprising a plurality of recipes and a plurality of food items, by:
navigating to the recipe by the user, the recipe including a number of recipe food items needed to prepare the recipe;
aggregating the recipe to the meal data object, including aggregating the recipe food items to the food items of the meal data object;
for each recipe food item of the recipe that is already present in the food items of the meal data object, adding a quantity of the recipe food item to a quantity of the food item of the meal data object;
for each recipe food item of the recipe that is absent from the food items of the meal data object, adding a food item to the meal data object for the recipe food item, including setting a quantity of the food item of the meal data object as a quantity of the recipe food item within the recipe;
a second computer program part to publish the meal data object so that the meal data object is viewable by a plurality of users; and,
a third computer program part to navigate a plurality of meal data objects, including the meal data object, by the users, including viewing the meal data objects.

20. The computer-readable medium of claim 19, the computer program further comprising at least one of:
a fourth computer program part to generate a shopping list of the food items needed to prepare the recipes of a selected meal data object; and,
a fifth computer program part to output an instruction package for the selected meal data object.
